(19) United States
(12) Patent Application Publication
(10) Pub. No.: US 2002/0093703 A1
(43) Pub. Date: Jul. 18, 2002

(54) Optical network elements having management tables for mapping path attributes to reference optical values

(76) Inventor: Yoshiharu Maeno, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/046,718

(22) Filed: Jan. 17, 2002

(30) Foreign Application Priority Data
Jan. 17, 2001 (JP) 2001-008370

(51) Int. Cl. H04B 10/08; H04B 10/20; H04J 14/00

(52) U.S. Cl. 359/110; 359/118

(57) ABSTRACT

In an optical network, a logical channel is established between two optical switches in response to a control message over multiple optical links. At least one optical transmission element is connected in the links for establishing a number of paths between the first and second optical switches. A controller, associated with the optical transmission element, has a memory in which it creates an entry in response to the control message for mapping a number of sets of attributes of each logical channel to a corresponding number of reference optical intensity values. A number of such entries are created in the memory when multiple logical channels are established through the network. From the memory, the controller measures the optical intensity of each optical link and compares it with the reference optical intensity value mapped in the memory to the logical channels accommodated in the measured link and performs management of the optical transmission element based on the result of the comparison.

### BACKGROUND OF THE INVENTION

1. Field of the Invention

The present invention relates generally to optical communication networks and more particularly to an optical communication network where the optical transmission elements are connected in a plurality of optical transmission links between optical switching systems.

2. Description of the Related Art

In an optical backbone network such as SONET (Synchronous Optical NETwork), wavelength division multiplexing technique is used for transmitting optical signals of different wavelengths on a shared optical link. The number of optical signals that can be multiplexed on an optical link has exceeded one-hundred. In a prior art optical communication network as disclosed in Japanese Patent Publication 2000-174710, the network assigns a “path” (end-to-end logical channels) to a user's request for setting up a channel over an optical multiplex link. Before users' electrical signal are wavelength-division multiplexed, they are converted in respective optical transmitters to different wavelengths and transmitted to an optical transmission link. Along the transmission link, optical amplifiers are spaced at intervals to amplify the transmitted multiplex signal. At the remote end of the link, the multiplex signal is demultiplexed into component wavelength signals, which are converted by respective optical receivers to electrical signals, which are transmitted to desired user sites. When a path is established through the network, two control messages are successively sent to the transmission link, one containing the path setup or release indication for establishing or releasing a local connection in a source switch and establishing or releasing a remote connection in a destination switch, and the other indicating the number of paths to be established or released. According to the number of paths established in the network, optical amplifiers are controlled so that they maintain a constant gain.

Japanese Patent Publication 2000-196534 discloses a similar optical communication network which prevents the degradation of nonlinear characteristics and signal to noise ratio of optical amplifiers caused by differing numbers of optical paths. Further, Japanese Patent Publication 2000-236301 discloses an optical communication network in which the output level of an optical amplifier is maintained constant according to the number of established paths.

However, whenever a path is established or released, the prior art optical amplifiers cannot precisely adapt to a change in the number of paths established in the network according to an attribute of each path, such as transmission rate and data format. Additionally, if the input signal to the optical amplifier is a multiplex signal, the optical level adjustment cannot quickly and precisely be made on a per “mux” group (multiplex group) according to the number of paths associated with a mux group.

Furthermore, the maximum transmission speed of the prior art optical network is limited to a large extent by the “opaque” nature of the interface (i.e., conversion is necessary between electrical signal and optical signal) at each end of the optical transmission link. Other shortcomings of the “opaque” interface are the inability to perform simultaneous switching of multiple paths and the inability to perform adaptive switching to different transmission speeds and different data formats.

In order to overcome these shortcomings, a “transparent” optical switching system has been developed for use at each end of the optical link. Although the transparent optical switching system has the ability to perform simultaneous switching of multiple paths and adaptive switching according to different transmission speeds and different data formats, one disadvantage of the prior art is the inability to perform fault monitoring and level adjusting of optical signals due to the absence of electrical signal processing.

### SUMMARY OF THE INVENTION

It is therefore an object of the present invention to provide an optical network having a path management table for autonomous precision management of transmission elements disposed in a plurality of optical is transmission links according to the attributes of paths established in the network.

A further object of the present invention is to provide an efficient transmission of multicast control messages for path establishment, attribute modification and path cleardown operations.

According to a first aspect of the present invention, there is provided an optical network comprising a first optical switch for connecting a plurality of input ports to a plurality of output ports in response to a control message, and a second optical switch for connecting a plurality of input ports to a plurality of output ports in response to the control message. A plurality of optical transmission links connect the output ports of the first optical switch to the input ports of the second optical switch. At least one optical transmission element is disposed in the optical transmission links for establishing a plurality of logical channels from the input ports of the first optical switch to the output ports of the second optical switch. A controller is associated with the optical transmission element, the controller including a memory for creating an entry for each of the logical channels in response to the control message for mapping at least one attribute of each logical channel to a reference optical intensity value. For management of the optical transmission element, the controller measures optical intensity of each of the transmission links and compares the measured optical intensity with the reference optical intensity value mapped in the memory to the logical channel established through the measured transmission link.

According to a second aspect, the present invention provides an optical network element comprising an optical transmission element disposed in a plurality of optical links for establishing a plurality of logical channels in the optical links, monitoring circuitry for detecting an optical intensity of each of the optical links, a management table for defining a plurality of entries corresponding to the logical channels, each of the entries mapping at least one attribute of the corresponding logical channel to a reference optical intensity value, and a controller for creating an entry in the management table for each of the logical channels in response to the control message for mapping at least one attribute of each logical channel to a reference optical intensity value. The controller measures optical intensity of each of the optical links and comparing the measured optical intensity with the reference optical intensity value mapped in the management table to the logical channel established through the measured optical link for management of the optical transmission element.

According to a third aspect, the present invention provides a management method for an optical network element connected in a plurality of optical transmission links which accommodate a plurality of logical channels, the method comprising the steps of creating an entry in a memory in response to a control message for mapping at least one attribute of a logical channel accommodated in one of the transmission links to a reference optical intensity value, measuring optical intensity of each of the optical transmission links, and comparing the detected optical intensity with the reference optical intensity mapped in the memory to at least one logical channel accommodated in the measured optical transmission link.

According to a fourth aspect, the present invention provides a control method for an optical communication network in which at least one optical transmission element is disposed in a plurality of optical transmission links which accommodate a plurality of logical channels, between a first optical switch and a second optical switch, the method comprising the steps of: transmitting a setup message from a transmit site, establishing a connection in the first optical switch in response to the setup message and a connection in the second optical switch in response to the setup message, creating an entry in a memory in response to the control message for mapping at least one attribute of a logical channel accommodated in one of the transmission links to a reference optical intensity value, measuring optical intensity of each of the optical transmission links, comparing the detected optical intensity with the reference optical intensity mapped in the memory to at least one logical channel accommodated in the measured optical transmission link, and controlling the optical transmission element according to a result of the comparison step.

### BRIEF DESCRIPTION OF THE DRAWIGNS

The present invention will be described in detail further with reference to the following drawings, in which:

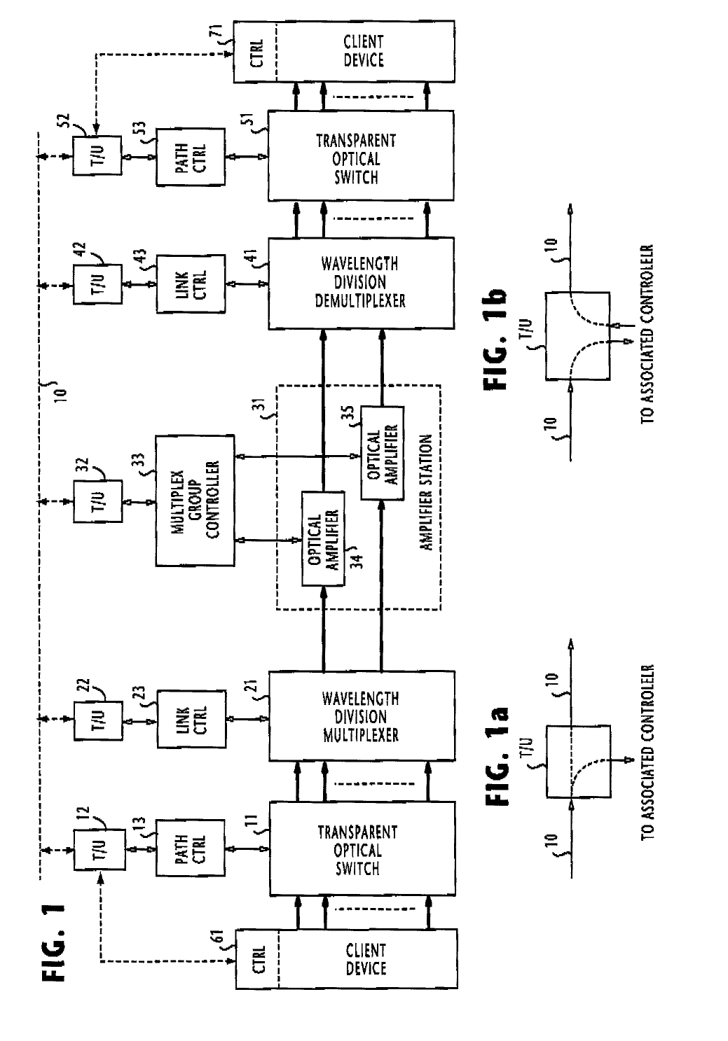

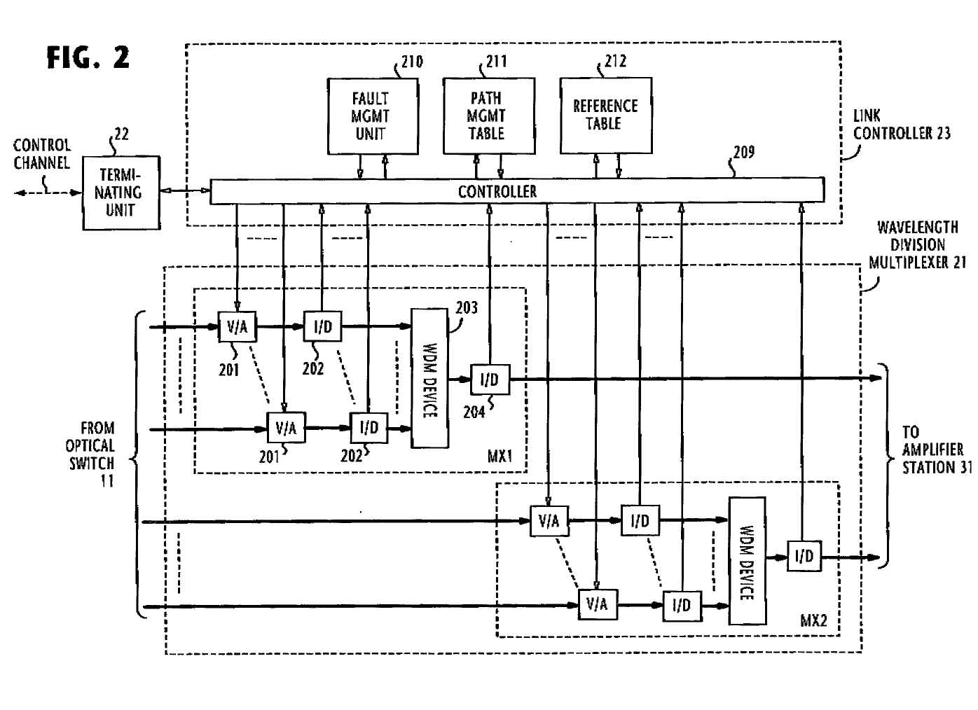

FIG. 1 is a block diagram of an optical network of the present invention, and

FIGS. 1a and 1b show details of a terminating unit operating in a parallel transfer mode and a serial transfer mode, respectively;

FIG. 2 is a block diagram of a wavelength division multiplexer and an associated link controller;

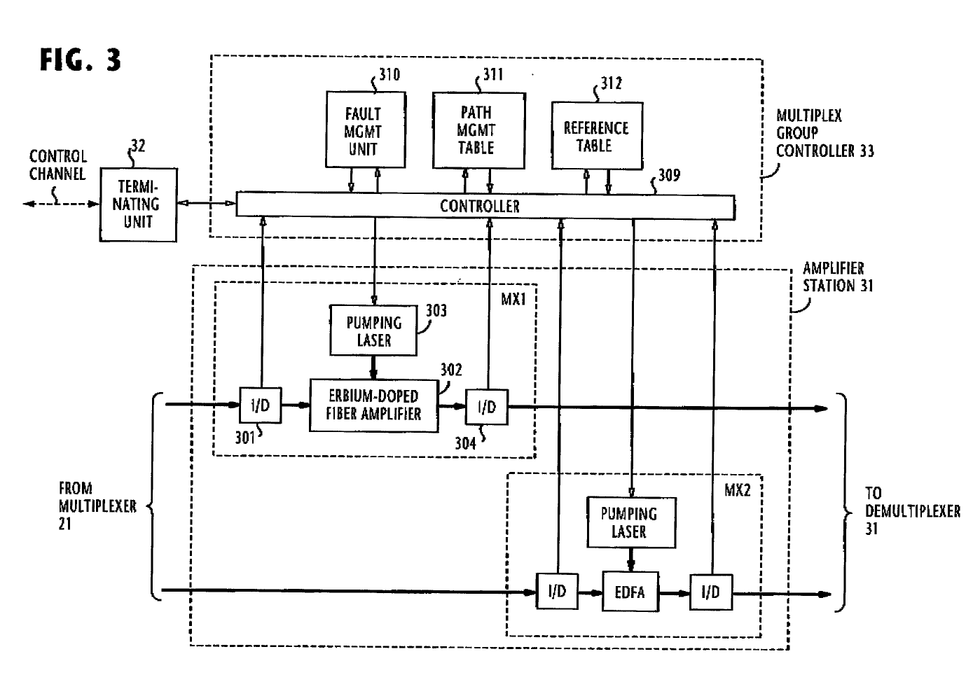

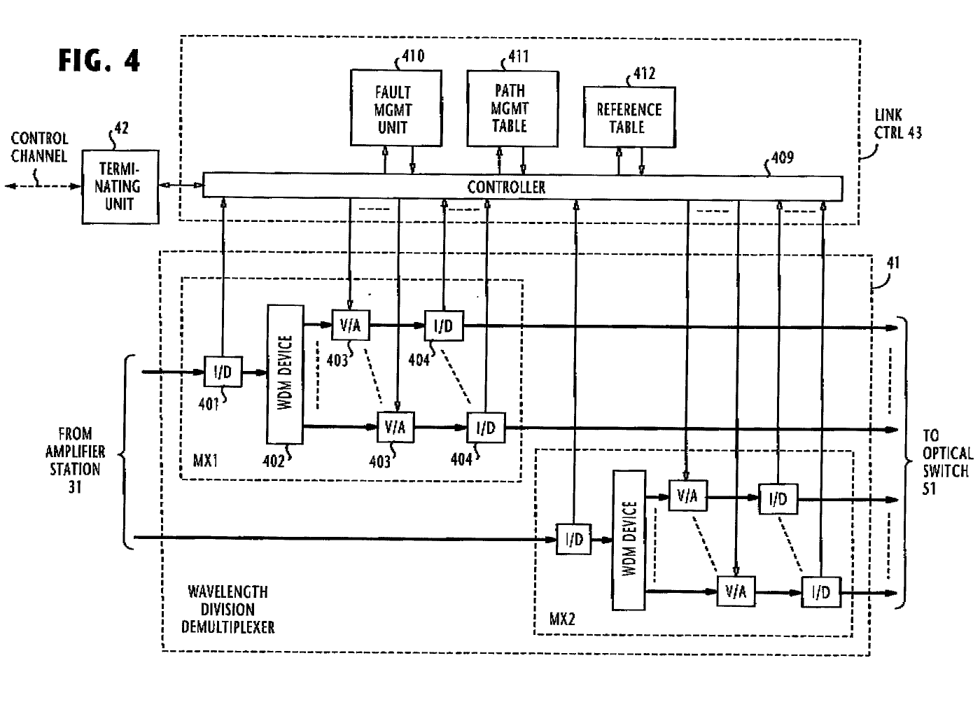

FIG. 3 is a block diagram of an amplifier station and an associated mux group controller;

FIG. 4 is a block diagram of a wavelength division demultiplexer and an associated link controller;

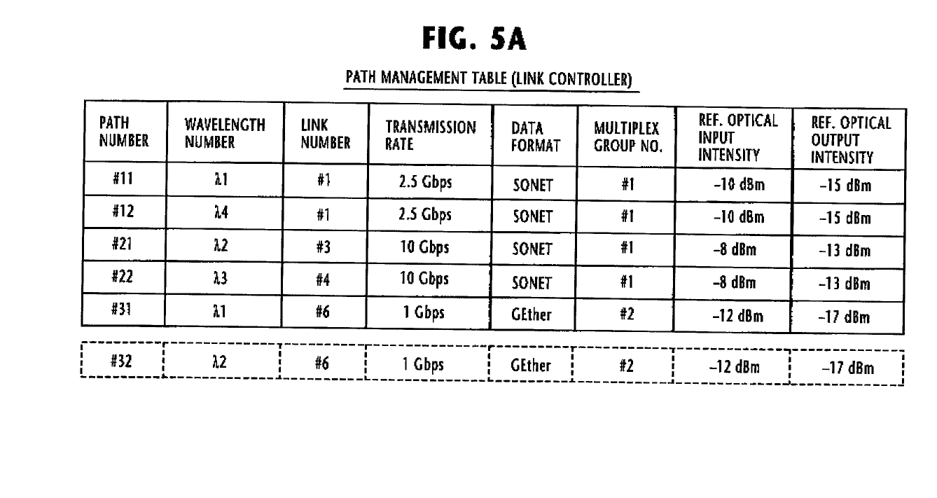

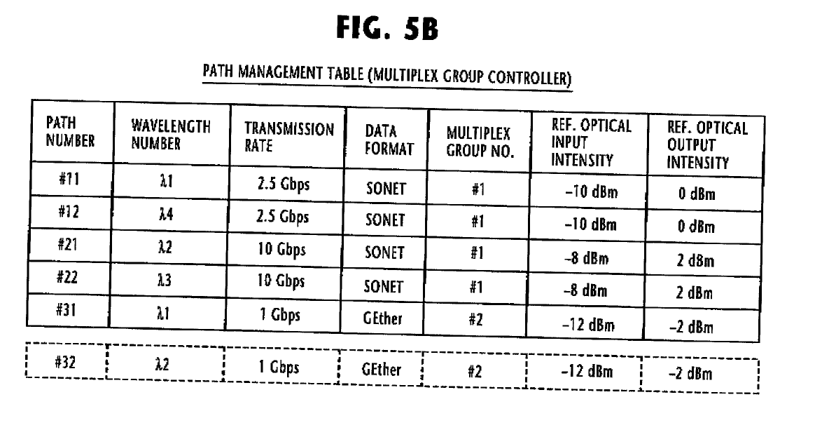

FIG. 5A is an illustration of a path management table maintained by link controllers;

FIG. 5B is an illustration of a path management table maintained by a mux group controller;

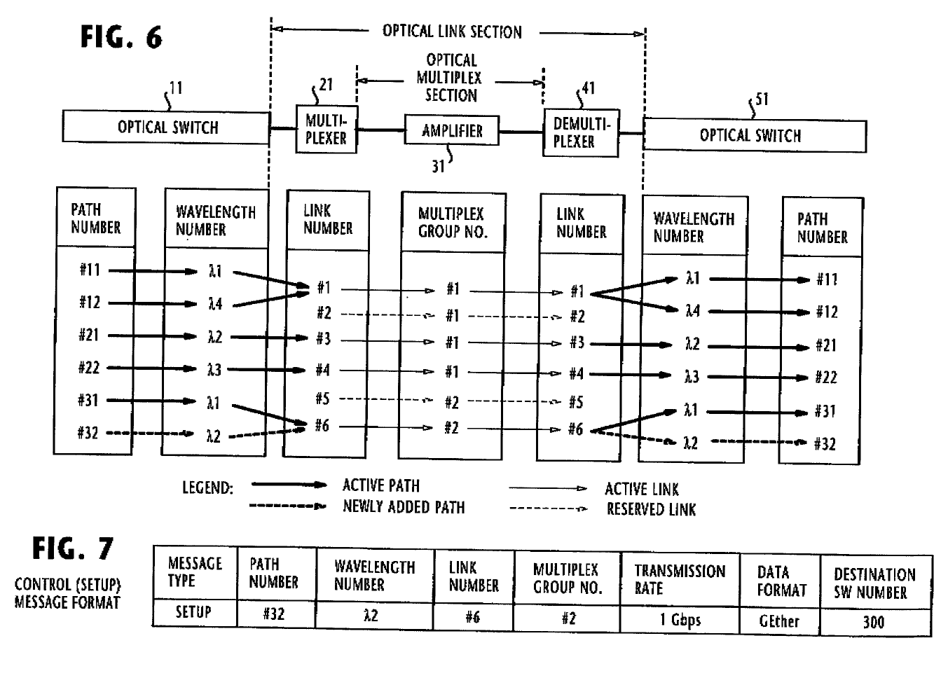

FIG. 6 is a schematic diagram of a representative network configuration for purposes of explanation;

FIG. 7 is an illustration of a control message format;

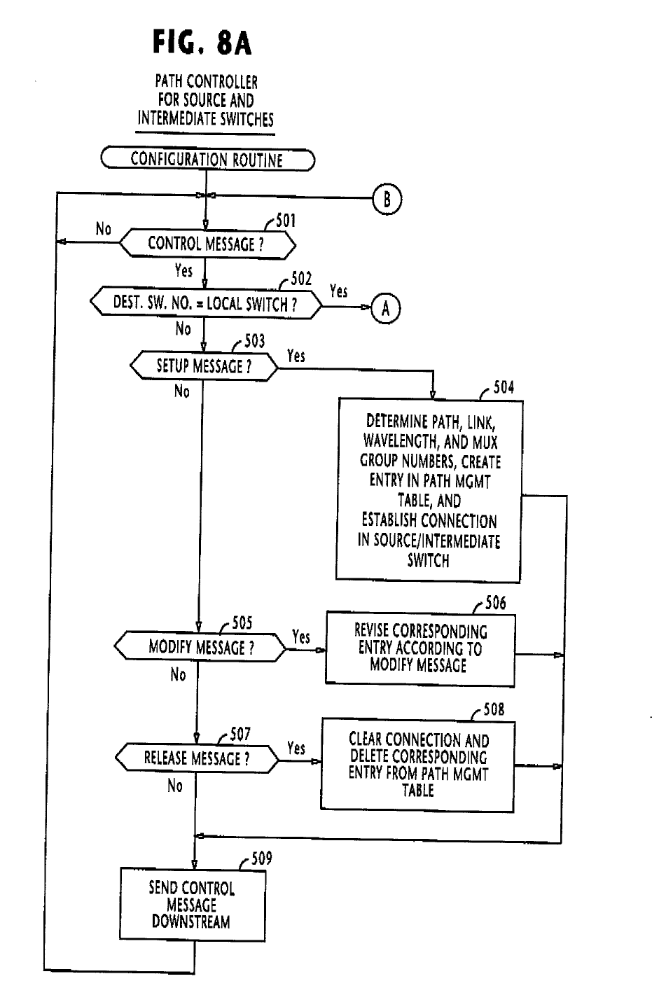

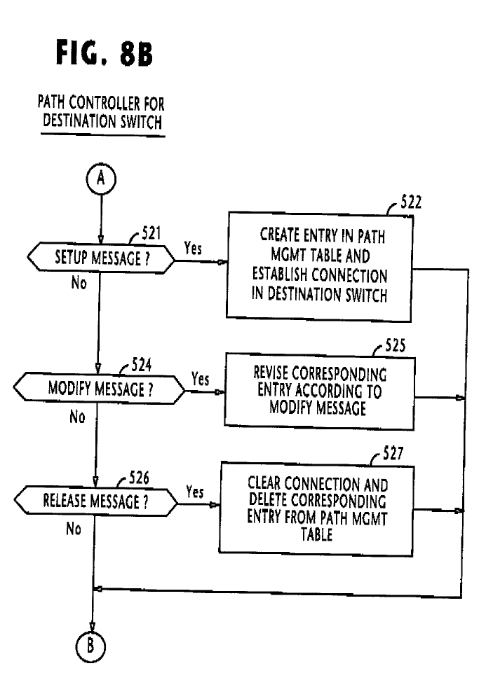

FIG. 8A is a flowchart of the operation of a path controller associated with a source or an intermediate switch in response to receipt of a control message;

FIG. 8B is a flowchart of the operation of a path controller associated with a destination switch in response to receipt of the control message;

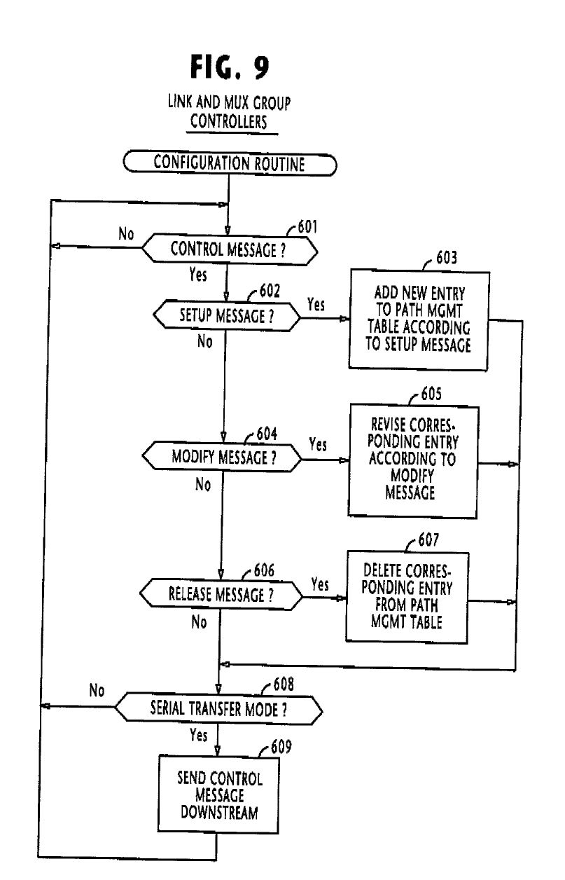

FIG. 9 is a flowchart of the operation of link and mux group controllers of the network in response to the control message;

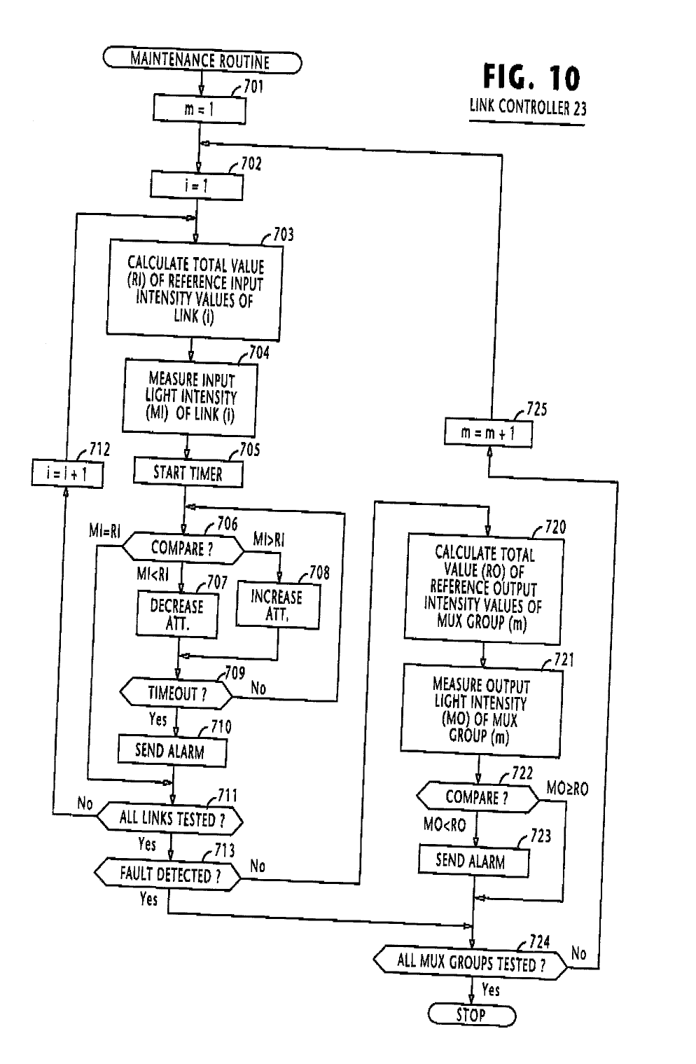

FIG. 10 is a flowchart of a maintenance routine of the upstream-side link controller;

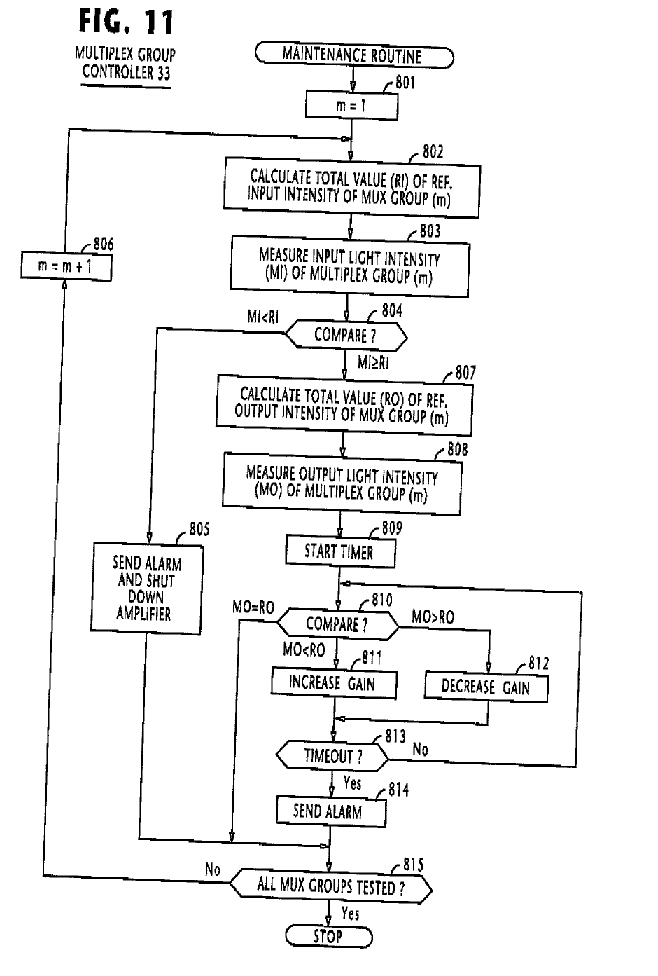

FIG. 11 is a flowchart of a maintenance routine of the mux group controller; and

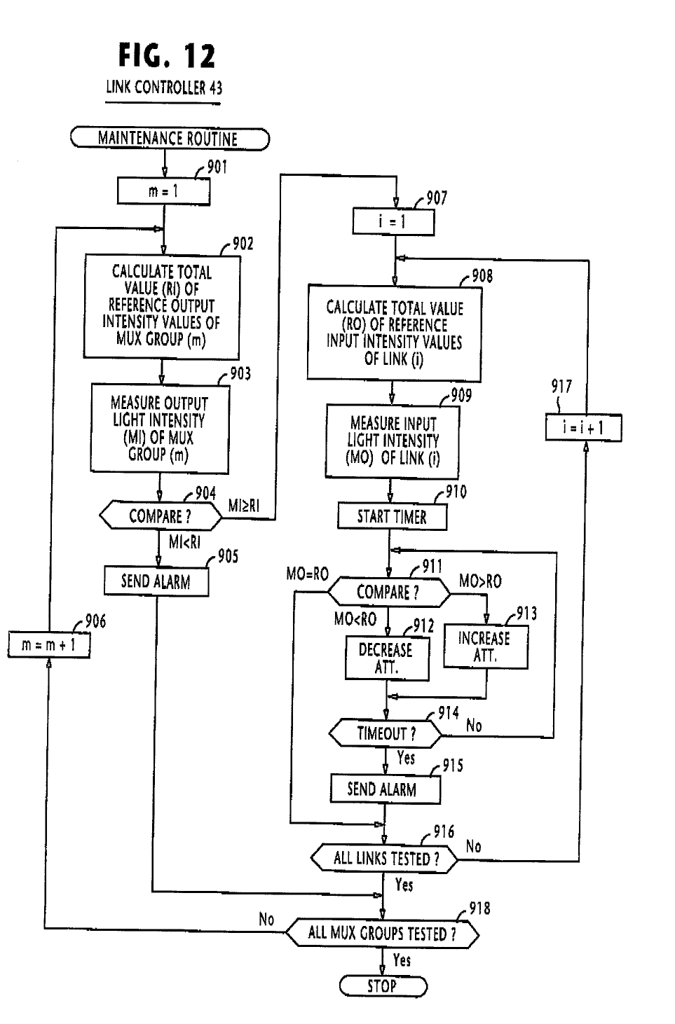

FIG. 12 is a flowchart of a maintenance routine of the downstream-side link controller.

### DETAILED DESCRIPTION

Referring to FIG. 1, there is shown an optical communications network according to the present invention. The optical network is comprised of transparent optical switches 11 and 51 to which client devices 61 and 71 are respectively terminated. Optical switches 11 and 51 are interconnected by a plurality of optical transmission links in which at least one network element is provided. Optical switch 11 has a plurality of input ports to which the output ports of the client device 61 are connected and a plurality of output ports connected by optical links to a wavelength division multiplexer 21. Optical switch 51 has a plurality of input ports to which a wavelength division demultiplexer 41 are connected through optical links and a plurality of output ports connected to the input ports of the client device 71. Optical links between the switch 11 and the multiplexer 21 are identified by link numbers and the optical links between the demultiplexer 41 and the switch 51 are identified by the same link numbers. Optical switches 11 and 51 are identified by a switch number.

Optical switch 51 may operate as an intermediate switch if the remote client device is connected to a remote destination switch.

In the illustrated example, at least one amplifier station 31 is disposed between the WDM network elements 21 and 41 for amplifying traffic messages from the client device 61 to the client device 71. A similar set of network elements may be provided for traffic messages in the opposite direction of transmission. For simplicity, the description of only one way of transmission is given.

A plurality of terminating units 12, 22, 32, 42 and 52 are connected to a common control link 10 for transmission of multicast control messages. Associated respectively with the terminating units 12, 22, 32, 42 and 52 are a path controller 13, a link controller 23, a multiplex (mux) group controller 33, a link controller 43 and a path controller 53. As will be described below, each of these controllers is provided with a path management table.

As shown in FIG. 1a, when operating in a parallel transfer mode, each of the intermediate terminating units 22, 32, 42 receives and duplicates an incoming control message and transmits the copies, one to a downstream terminating unit and the other to the associated controller. This transfer mode is suitable for applications where fast transmission is important.

Each of the intermediate terminating units 22, 32, 42 can operate in a serial transfer mode, in which the terminating unit receives and forwards the incoming control message to the associated controller, as shown in FIG. 1b. After processing the control message, the controller forwards a copy of the received control message downstream via the associated terminating unit. This serial transfer mode is suitable for applications where it is important that the downstream network element must activate following the operation of the upstream network element.

When establishing a path through the network, the source client device 61 sends a control message to the terminating unit 12, indicating a message type, a data format and a destination switch number. Terminating unit 12 passes it on to the path controller 13. As will be discussed in detail later, the path controller 13 controls the associated optical switch 11 to establish a connection between its input and output ports and formulates a setup message and passes it on to the terminating unit 12, which forwards it as a multicast message onto the control link 10. In response to the multicast setup message, the link controllers 23, 43 and mux group controller 33 each create an entry in a path management table for setting attributes of the path, and the destination path controller 53 controls the associated optical switch 51 to establishes a connection between its input and output ports.

All paths of the network are carried on one or more parallel multiplex (mux) groups. For purposes of explanation, two mux groups MX1 and MX2 are illustrated.

Within each mux group, each path is assigned a unique wavelength number. In each entry of the path management table, a number of attributes associated with the established path are stored. Link controllers 23, 43 and the mux group controller 33 are further provided with a reference table in which a plurality of sets of attributes such as wavelength, transmission rate and data format are mapped to a plurality of sets of optical reference input and output intensity values. Controllers 23, 33 and 43 autonomously perform fault finding and intensity adjustment (maintenance) routines using the reference values as decision thresholds according to different attributes of the paths established in the network. When these controllers perform the maintenance routine, optical reference input and output intensity values are read from their reference table and stored into corresponding path entries of their path management table.

As shown in detail in FIG. 2, the wavelength division multiplexer 21 is divided into mux groups MX1 and MX2 of similar configuration. Each mux group includes a plurality of optical variable attenuators 201 connected to a first group of optical links from the switch 11, a plurality of optical input intensity detectors 202 respectively connected to the variable detectors 201, and a WDM (wavelength division multiplex) device 203 connected to the intensity detectors 201, and an optical output intensity detector 204 connected to the output of the WDM device 203.

Each of the intensity detectors 202 detects the light intensity of the optical signal from the associated link and supplies an intensity indicating signal to the link controller 23, while transparently passing the incoming optical signal to the WDM device 203. Likewise, the intensity detector 204 detects the light intensity of the signal from the WDM device 203 and supplies an intensity indicating signal to the link controller 23, while transparently passing the incoming optical signal downstream.

Link controller 23 includes a controller 209, a fault management unit 210, a path management table 211 and a reference table 212. Controller 209 receives the control message from the path controller 13 via the terminating unit 22 and creates an entry in the path management table 211 when the client device 61 has transmitted a setup message requesting that a path should be established between the optical switches 11 and 51. Data stored in an entry created for each path in the path management table 211 indicates a path number, a wavelength number, a transmission rate, a data format, a mux group number and an associated link number as illustrated in FIG. 5A. When such a path entry is created, the controller 209 reads reference input and output intensity values from the reference table 212 and stores them into the corresponding entries of the path management table 211 as illustrated in FIG. 5A.

Controller 209 performs overall management of the wavelength division multiplexer 21 by constantly monitoring the intensity indicating signals of the incoming and outgoing optical links. Using the path management table 211 and reference table 212, the controller 209 performs fault finding and intensity adjustment routines in a manner as will be discussed later. When a fault is detected in the multiplexer 21, the controller 209 sends an alarm signal to the fault management unit 210, which in turn formulates and transmits a fault report to the client device 61 via the terminating unit 22.

FIG. 3 shows details of the amplifier station 31. Amplifier station 31 is divided into two mux groups MX1 and MX2 of similar configuration. Each of these mux groups includes an input intensity detector 301 which detects the intensity of the input signal of the associated mux group received from the multiplexer 21 and supplies an intensity indicating signal to the mux group controller 33. Detector 301 transparently passes the optical signal on to an amplifying medium such as an erbium-doped fiber amplifier 302 for light amplification wing energy pumped from a pumping laser 303. A control signal is supplied to the pumping laser 303 from the mux group controller 33 for making adjustment of output optical level. The amplified optical multiplex signal is passed through an output intensity detector 304 to the associated outgoing optical link. Detector 304 monitors the outgoing optical multiplex signal and informs the mux group controller 33 of the detected output intensity.

Multiplex group controller 33 includes a controller 309, a fault management unit 310, a path management table 311 and a reference table 312. Controller 309 receives the control message via the terminating unit 32 and creates a path entry in the path management table 311 in response to the setup message. Data stored in the path entry in the path management table 311 indicates path number, wavelength number, transmission speed, data format and the associated mux group number as illustrated in FIG. 5B. When an entry is created in the path management table 311, the controller 309 also reads reference input and output intensity values from the reference table 312 and stores them into the path management table 311 as illustrated in FIG. 6B.

Mux group controller 309 is also an autonomous unit for performing overall management of the amplifier station 31 by constantly monitoring the intensity indicating signals of the incoming and outgoing optical links. Using the path management table 311, a maintenance routine (fault finding and intensity adjustment) is performed in a manner as will be discussed later. When a fault is detected in the amplifier station 31, the mux group controller 309 sends an alarm signal to its fault management unit 310, which in turn formulates and transmits a fault report to the client device 61 via the terminating unit 32.

As shown in detail in FIG. 4, the wavelength division demultiplexer 41 is also divided into two mux groups MX1 and MX2 of identical configuration. Each mux group of the demultiplexer 41 includes an input intensity detector 401 connected to the associated incoming optical link from the amplifier station 31, a WDM (wavelength division demultiplex) device 402 where the multiplex signal is decomposed into component wavelength signals, a plurality of variable attenuators 403 for respectively controlling the intensity of the outputs of WDM device 402. A plurality of intensity detectors 404, connected to the variable attenuators 403, produce intensity signals indicating the intensity of outgoing wavelength signals sent to the optical switch 51.

Link controller 43 includes a controller 409, a fault management unit 410, a path management table 411 and a reference table 412. Controller 409 receives a control message from the client device 61 via the terminating unit 42 and creates a path entry in the path management table 411. Data stored in the path entry includes the path number, wavelength number, transmission speed, data format, mux group number and the associated link number as illustrated in FIG. 5A. When an entry is created in the path management table 411, the controller 409 also reads reference input and output intensity values from the reference table 412 and stores them into corresponding entries of the path management table 411 (FIG. 6A).

Controller 409 autonomously performs management of the wavelength division demultiplexer 41 by constantly monitoring the intensity indicating signals of the incoming and outgoing optical links. Using the path management table 411, a maintenance is performed. When a fault is detected in the demultiplexer 41, the controller 409 sends an alarm signal to the fault management unit 410, which in turn transmits a fault report to the client device 61 via the terminating unit 42.

In FIG. 6, one example of paths is shown established between optical switches 11 and 51. Six logical channels are pre-assigned path numbers #11, #12, #21, #22, #31 and #32 of which path number #32 represents a newly added path, and the rest representing active paths. The mux group MX1 is identified by multiplex group number #1 in which path numbers #11, #12, #21, #22 are multiplexed by wavelength λ1, λ4, λ2 and λ3. Wavelengths λ1 and λ4 are multiplexed by the optical switch 11 onto an active optical link with link number #1. Wavelengths λ2 and λ3 are carried on active optical links with link numbers #3 and #4, respectively. In the mux group MX2, identified by multiplex group number #2, path #31 is active and path #32 represents a newly added path. Pats #31 and #32 are respectively carried on wavelengths λ1 and λ2 which are multiplexed by the optical switch 11 onto an active optical link with link number #6. Links #2 and #5 are reserved links of mux groups #1 and #2, respectively.

The data format of a control (setup) message that can be used to set up the new path #32 is shown in FIG. 7. The control message includes a plurality of fields for indicating the message type, path number, wavelength number link number, multiplex group number, transmission rate and data format. In the case of a newly added path #32, the control message indicates that it is a setup message and contains path number #32, wavelength number λ2, link number #6, multiplex group number #2, transmission rate of 1 Gbps, the data format of Gigabit Ethernet (GEther), and the destination switch number is “300”, for example.

In each of the path management tables of path controllers, link controllers and mux group controller, an entry is created when a path is established in the network, or the entry is updated when attributes of a path are modified or the path of the entry is released. The following is a description of a configuration routine of the path controller associated with source, intermediate or destination switch with the aid of flowcharts shown in FIGS. 8A and 8B.

In FIG. 8A, a configuration routine of the path controller starts when it receives a control message at decision step 501. At step 502, the path controller checks to see if the destination switch number contained in the received message identifies the associated local switch. If the associated switch is a source or intermediate switch, the decision at step 502 is negative and flow proceeds to step 503 to check to see if the message is a setup message. If so, flow proceeds to step 504 to determine a path number, a link number, a wavelength number and a mux group number, and create an entry in the path management table with the determined numbers and the data contained in the received message. Further, the path controller controls the associated local switch to establish a connection between an input port and an output port corresponding to the determined link number. Flow proceeds to step 509 to reformulate the received control message with the determined numbers and transmits it downstream, and returns to the starting point of the routine.

If the received message is other than the setup message, flow proceeds from decision step 503 to step 505 to determine whether the message is a modify message. If so, flow proceeds to step 506 to revise the corresponding entry of the path management table according to the modify message and proceeds to step 509 for transmitting the received modify message downstream.

If the received message is other than the modify message, flow proceeds from decision step 505 to step 507 to determine whether the message is a release message. If so, flow proceeds to step 508 to clear the connection in the associated local switch and delete the corresponding entry of the path management table and proceeds to step 509 for transmitting the received release message downstream.

If the associated switch is a destination switch, the decision at step 502 is affirmative and flow proceeds step 521 (FIG. 8B) to check to see if the received message is a setup message. If so, flow proceeds to step 522 to create an entry in the path management table with the information contained in the received setup message and establish a connection in the associated destination switch, and return to the starting point of the routine.

If the received message is other than the setup message, flow proceeds from decision step 521 to step 524 to determine whether the message is a modify message. If so, flow proceeds to step 525 to revise the corresponding entry of the path management table according to the modify message and returns to the starting point of the routine.

If the received message is other than the modify message, flow proceeds from decision step 524 to step 526 to determine whether the message is a release message. If so, flow proceeds to step 527 to clear the connection in the associated destination switch and delete the corresponding entry of the path management table and returns to the starting point of the routine.

The configuration routine of the link controllers 23, 43 and mux group controller 33 proceeds according to the flowchart of FIG. 9 as follows.

A configuration routine of each of the link and mux group controllers starts when it receives a control message at decision step 601. At step 602, the controller checks to see if the message is a setup message. If so, flow proceeds to step 603 to create an entry in the path management table according to the data contained in the received setup message. Flow proceeds to step 608 to determine if the controller is operating in a serial transfer mode. If not, control returns to the starting point of the routine. If the controller is operating in a serial transfer mode, flow proceeds to step 609 to transmit the received message downstream before returning to the starting point of the routine.

If the received message is other than the setup message, flow proceeds from decision step 602 to step 604 to determine whether the message is a modify message. If so, flow proceeds to step 605 to revise the corresponding entry of the path management table according to the modify message and proceeds to serial-parallel mode determination step 608.

If the received message is other than the modify message, flow proceeds from decision step 604 to step 606 to determine whether the message is a release message. If so, flow proceeds to step 607 to delete the corresponding entry of the path management table and proceeds to serial-parallel mode determination step 608.

In this way, if path number #32 is assigned to the established path, a new entry is created in each of the path management tables of FIGS. 5A and 5B and a corresponding set of reference optical input and output intensity values is inserted into the new entry, as indicated by dotted lines.

The operation of link controllers 23, mux group controller 33 and link controller 43 during a maintenance routine will be described below with the aid of the flowcharts of FIGS. 10, 11 and 12, respectively.

In FIG. 10, the link controller 23 initially sets a variable “m” to 1 (step 701) and a variable “i” to 1 (step 702), where the variables “m” and “i” correspond to a mux group number and a link number, respectively. Controller 23 proceeds to step 703 to examine its path management table (FIG. 5A) and calculates a total value (RI) of reference input intensity values of link (i). For example, when the variables “m” and “i” are 1, the link controller 23 determines that two pats #11 and #12 are associated with the link number #1 and each of these paths is given a reference input intensity value of −10 dBm which may vary depending on the attributes of each path.

Link controller 23 proceeds to step 704 to measure the input light intensity (MI) of link (i) as indicated by the signal from the corresponding intensity detector 202 and starts a timer at step 705. At decision step 706, the measured input light intensity MI is compared with the total reference intensity value RI. If MI<RI, flow proceeds to step 707 to decrease the attenuation of the variable attenuator 201 of incoming link (i). Conversely, if MI>RI, flow proceeds to step 708 to increase the attenuation. At step 709, the link controller 23 checks to see if the timer has expired. If there is a fault in the link (i), the timer runs out and the link controller 23 branches out timeout decision step 709 to step 710 to send an alarm signal to the fault management unit 210 and checks to see if all links have been tested. If not, the variable “i” is incremented by one at step 712 and returns to step 703 to repeat testing on the next optical link.

If there is no fault in the link under test, MI will become equal RI within the timeout period and flow proceeds from step 706 to step 711. If all links have been tested, flow exits step 711 and determines at step 713 whether a fault has been detected in an incoming optical link. If this is the case, the link controller 23 proceeds from step 713 to step 724 to check to see if all mux groups have been tested. If not, flow proceeds to step 725 to increment the variable “m” by one and returns to step 702 to repeat the process on the first link of the next mux group.

If no link fault has been detected in a mux group, the link controller 23 proceeds to test its outgoing optical link. In such instances, the decision at step 713 is negative and flow proceeds to step 720 to read reference output intensity values of mux group (m) from the path management table 211 and calculates a total value (RO) of the read reference output intensity values. For example, when the variable “m” is 1, the link controller 23 determines that four paths #11, #12, #21 and #22 are associated with the mux group number #1 and these paths have their attributes correspond to reference output intensity values of −15 dBm, −15 dBm, −13 dBm and −13 dBm.

Link controller 23 proceeds to step 721 to measure the output light intensity (MO) of mux group (m) as indicated by the signal from the corresponding intensity detector 204. Step 722 compares the measured value MO with the total reference output intensity value RO. If the measured value MO is much smaller tan the reference value RO, the link controller 23 determines that the WDM device 203 may have possibly failed and sends an alarm signal to the fault management unit 210 (step 723) and proceeds to step 724. If the measured value is equal to or higher than the total reference value, it is determined that there is no faulty part in the WDM device 203 and flow proceeds to step 724 to check to see if all mux groups have been tested. If so, flow proceeds to the end of the routine. Otherwise, the variable “m” is incremented by one at step 725 to repeat the testing on the first incoming link of the next mux group.

Therefore, if a fault is detected in an incoming link of a mux group, the controller 23 skips the testing of its outgoing link and proceeds to the testing of the incoming links of the next mux group.

In FIG. 11, the mux group controller 33 initially sets the variable “m” to 1 at step 801 and proceeds to step 802 to read reference input intensity values corresponding to the attributes of the paths associated with the mux group (m) from the path management table (FIG. 5B) and calculates the total value (RI) of the reference input intensity. At step 803, the input light intensity (MI) of mux group (m) as indicated by the signal from the corresponding intensity detector 301 is measured, and compared, at step 804, with the total reference intensity value RI. If the measured value is much smaller than the total reference value, the mux group controller 33 determines that the input circuit of the amplifier 302 may have possibly failed, and proceeds to step 805 to send an alarm signal to the fault management unit 310 and shuts down the optical amplifier 302 and proceeds to step 815. If all mux groups have not been tested, flow proceeds to step 806 to increment the variable “m” by one (step 806), and returns to step 802.

If step 804 indicates that MI≧RI, the mux group controller 33 determines that there is no fault in the input circuit of the optical amplifier 302 and advances to step 807 to calculate the total value RO of the reference output intensity of the mux group (m) and measures the output light intensity MO of mux group (m) from the corresponding intensity detector 304 (step 808) and starts a timer (step 809). While the timer is running, the mux group controller 33 compares the calculated total reference value with the measured value (step 810). If the measured value is smaller than the total reference value, the pumping laser 303 of mux group (m) is adjusted to increase the gain of amplifier 302. If the measured value is larger than the total reference value, the pumping laser 303 is adjusted to decrease the gain of amplifier 302. Steps 810, 811 and 812 are repeated until the timer runs out (step 813), indicating that the output circuit of the optical amplifier 302 is faulty, or before the timer runs out the decision at step 810 yields a result that MO=RO, indicating that the amplifier output circuit is working properly. If the timer expires at step 813, flow proceeds to step 814 to send an alarm signal to the fault management unit 310. At step 815, the mux group controller 33 checks to see if all mux groups have been tested. When all mux groups have been tested, the mux group controller 33 exits step 815 and terminates the maintenance routine.

In FIG. 12, the link controller 43 initially sets the variable “m” to 1 at step 901 and proceeds to step 902 to examine its path management table (FIG. 5A) to read all reference input intensity values of mux group (m) and calculates the total value RI of these reference values. Link controller 43 proceeds to step 903 to measure the input light intensity MI of mux group (m) as indicated by the signal from the corresponding intensity detector 401. At decision step 904, the measured input light intensity MI is compared with the total reference intensity value RI. If MI is mud smaller than RI (step 904), flow proceeds to step 905 to send an alarm signal to the fault management unit 410 and proceeds to step 918. If all mux groups have not been tested, flow proceeds to from step 919 to step 906 to increment the variable “m” by one, and returns to step 902 for testing the incoming link of the next mux group.

If MI is equal to or greater tan RI (step 904), the link variable “i” is set to 1 at step 907 and the total value RO of reference output intensity values of outgoing link (i) is calculated (step 908). At step 909, the output light intensity MO of link (i) is measured by the signal from the corresponding intensity detector 404 and a timer is started (step 910). While the timer is running, the measured value MO is compared with the total reference output intensity value RO (step 911). If MO<RO, flow proceeds to step 912 to decrease the attenuation of the corresponding variable attenuator 404 to increase the light intensity of outgoing link (i). If MO>RO, flow proceeds to step 913 to increase the attenuation to increase the light intensity of outgoing link (i). Steps 911, 912 and 913 are repeated until the timer expires, indicating that the outgoing link (i) is faulty, or before the timer expires the decision that MO=RO yields at step 911. When the timer expires, an alarm signal is sent to the fault management unit 410 (step 915).

At step 916, the link controller 43 checks to see if all links have been tested. If not the link variable “i” is incremented by one at step 917 and flow returns to step 908 to repeat the test on the next outgoing link. If all links if a given mux group have been tested (step 916), the link controller 43 ascertains that all mux groups have been tested (step 918). If all mux groups have been tested, the link controller 43 exits step 918 and terminates the maintenance routine.

If a fault is detected by any of the controllers 23, 33, 43, the associated fault management unit sends a fault report to the client device 61. In response, the client device may alter the configuration of the network by a control message according to the contents of the fault report.

What is claimed is:

1. An optical network comprising:
a first optical switch for connecting a plurality of input ports to a plurality of output ports in response to a control message;
a second optical switch for connecting a plurality of input ports to a plurality of output ports in response to said control message;
a plurality of optical transmission links for connecting the output ports of the first optical switch to the input ports of the second optical switch;
at least one optical transmission element disposed in said optical transmission links for establishing a plurality of logical channels from said plurality of input ports of the first optical switch to said plurality of output ports of the second optical switch; and
a controller associated with said optical transmission element, the controller including a memory and creating an entry in the memory for each of said logical channels in response to said control message for mapping at least one attribute of said each logical channel to a reference optical intensity value,
said controller measuring optical intensity of each of said transmission links and comparing the measured optical intensity with the reference optical intensity value mapped in said memory to the logical channel established through said measured transmission link for management of said optical transmission element.

2. The optical network of claim 1, wherein said controller calculates a total sum of reference optical intensity values mapped in said memory to a plurality of logical channels established through said each transmission link and compares the measured optical intensity with said total sum for management of said optical transmission element.

3. The optical network of claim 1, wherein said at least one attribute represents one of wavelength, transmission rate and data format.

4. The optical network of claim 1, wherein said controller revises said entry in response to a control message indicating a revision of said at least one attribute.

5. The optical network of claim 1, wherein said controller deletes said entry from said memory in response to a control message indicating a release of a logical channel, and wherein said first and second optical switches respond to the control message for clearing said logical channel.

6. The optical network of claim 1, wherein said controller detects a fault in said optical transmission element based on the measured optical value and a reference optical intensity value mapped in said memory.

7. The optical network of claim 1, wherein said optical transmission element comprises a wavelength division multiplexer for multiplexing optical signals from a plurality of optical links from said first optical switch into an optical multiplex signal.

8. The optical network of claim 1, wherein said optical transmission element comprises a wavelength division demultiplexer for demultiplexing an optical multiplex signal into a plurality of optical component signals.

9. The optical network of claim 1, wherein said optical transmission element comprises an optical amplifier.

10. The optical network of claim 7, wherein said wavelength division multiplexer further comprises:
a plurality of optical variable attenuators for controlling intensity of a plurality of incoming optical signals from said first optical switch; and
a plurality of optical intensity detectors for producing a plurality of signals indicating intensity of said incoming optical signals,
said controller controlling each of said optical variable attenuators according to a difference between the measured optical intensity and said reference intensity value mapped in said memory.

11. The optical network of claim 10, wherein said controller uses said difference for detecting a fault in one of a plurality of input circuits of said wavelength division multiplexer.

12. The optical network of claim 11, wherein said wavelength division multiplexer further comprises an output optical detector for producing a signal indicating intensity of an optical multiplex signal from said multiplexer, and wherein said controller uses the signal from the output optical detector as said measured optical intensity and detects a difference between the reference optical intensity and the measured optical intensity for detecting a fault in an output circuit of said wavelength division multiplexer.

13. The optical network of claim 8, wherein said wavelength division demultiplexer further comprises:
a plurality of optical variable attenuators for controlling intensity of optical component signals; and
a plurality of output optical detectors for producing signals respectively indicating intensity of said optical component signals,
said controller controlling said variable attenuators according to a difference between the measured optical intensity and said reference intensity value mapped in said memory.

14. The optical network of claim 13, wherein said wavelength division demultiplexer further comprises an input optical detector for producing a signal indicating intensity of said optical multiplex signal, and wherein said controller uses said difference for detecting a fault in an input circuit of said wavelength division demultiplexer.

15. The optical network of claim 9, wherein said optical amplifier comprises:
an optical amplifying medium for amplifying an optical multiplex signal;
an excitation energy source for pumping optical energy into the optical amplifying medium;
an input optical detector for producing a signal indicating intensity of an optical multiplex signal supplied to said optical amplifying medium, and
an output optical detector for producing a signal indicating intensity of the amplified optical multiplex signal from said optical amplifying medium,
said controller controlling said excitation energy source according to a difference between the measured optical intensity and said reference intensity value mapped in said memory.

16. The optical network of claim 1, wherein said at least one transmission element comprises a wavelength division multiplexer, an optical amplifier and a wavelength division demultiplexer connected in series in said optical transmission links, and wherein said controller is one of a plurality of first, second and third controllers associated with said multiplexer, said amplifier and said demultiplexer, respectively.

17. The optical network of claim 16, wherein said control message is a multicast message transmitted over a common channel to said first and second optical switches and to said first, second and third controllers.

18. An optical network element comprising:
an optical transmission element disposed in a plurality of optical links for establishing a plurality of logical channels in said optical links;
monitoring circuitry for detecting an optical intensity of each of said optical links;
a management table for defining a plurality of entries corresponding to said logical channels, each of said entries mapping at least one attribute of the corresponding logical channel to a reference optical intensity value; and
a controller for creating an entry in said management table for each of said logical channels in response to said control message for mapping at least one attribute of said each logical channel to a reference optical intensity value,
said controller measuring optical intensity of each of said optical links and comparing the measured optical intensity with the reference optical intensity value mapped in said management table to the logical channel established through the measured optical link for management of said optical transmission element.

19. The optical network element of claim 18, wherein said controller calculates a total sum of reference optical intensity values mapped in said management table to a plurality of logical channels established through said measured optical link and compares the measured optical intensity with said total sum for management of said optical transmission element.

20. The optical network element of claim 18, wherein said at least one attribute represents one of wavelength, transmission rate and data format.

21. The optical network element of claim 18, wherein said optical transmission element is a wavelength division multiplexer.

22. The optical network element of claim 18, wherein said optical transmission element is a wavelength division demultiplexer.

23. The optical network element of claim 18, wherein said optical transmission element is an optical amplifier.

24. The optical network of claim 20, wherein said wavelength division multiplexer further comprises:
a plurality of optical variable attenuators for controlling intensity of a plurality of incoming optical signals from said first optical switch; and
a plurality of optical intensity detectors for producing a plurality of signals indicating intensity of said incoming optical signals,
said controller controlling each of said optical variable attenuators according to a difference between the measured optical intensity and said reference intensity value mapped in said memory.

25. The optical network of claim 24, wherein said controller uses said difference for detecting a fault in one of a plurality of input circuits of said wavelength division multiplexer.

26. The optical network of claim 25, wherein said wavelength division multiplexer further comprises an output optical detector for producing a signal indicating intensity of an optical multiplex signal from said multiplexer, and wherein said controller uses the signal from the output optical detector as said measured optical intensity and detects a difference between the reference optical intensity and the measured optical intensity for detecting a fault in an output circuit of said wavelength division multiplexer.

27. The optical network of claim 22, wherein said wavelength division demultiplexer further comprises:
a plurality of optical variable attenuators for controlling intensity of optical component signals; and
a plurality of output optical detectors for producing signals respectively indicating intensity of said optical component signals,
said controller controlling said variable attenuators according to a difference between the measured optical intensity and said reference intensity value mapped in said memory.

28. The optical network of claim 27, wherein said wavelength division demultiplexer further comprises an input optical detector for producing a signal indicating intensity of said optical multiplex signal, and wherein said controller uses said difference for detecting a fault in an input circuit of said wavelength division demultiplexer.

29. The optical network of claim 23, wherein said optical amplifier comprises:
an optical amplifying medium for amplifying an optical multiplex signal;
an excitation energy source for pumping optical energy into the optical amplifying medium;
an input optical detector for producing a signal indicating intensity of an optical multiplex signal supplied to said optical amplifying medium, and
an output optical detector for producing a signal indicating intensity of the amplified optical multiplex signal from said optical amplifying medium,
said controller controlling said excitation energy source according to a difference between the measured optical intensity and said reference intensity value mapped in said memory.

30. A management method for an optical transmission element connected in a plurality of optical transmission links which accommodate a plurality of logical channels, the method comprising the steps of:
creating an entry in a memory in response to a control message for mapping at least one attribute of a logical channel accommodated in one of said transmission links to a reference optical intensity value;
measuring optical intensity of each of said optical transmission links;
comparing the detected optical intensity with the reference optical intensity mapped in said memory to at least one logical channel accommodated in said measured optical transmission link; and
controlling said optical transmission element according to a result of the comparison step.

31. The management method of claim 30, wherein the comparison step further comprises calculating a total sum of reference optical intensity values mapped in said memory to a plurality of logical channels established through said measured transmission link and compares the measured optical intensity with said total sum for management of said optical transmission element.

32. The management method of claim 30, wherein said at least one attribute represents one of wavelength, transmission rate and data format.

33. The management method of claim 30, further comprising the step of adjusting optical intensity level of each of said transmission links based on a result of the comparison step.

34. The management method of claim 30, further comprising the step of detecting a fault in said optical network element based on a result of the comparison step.

35. The management method of claim 30, wherein the comparison step comprises calculating a total value of reference optical intensity values mapped in said memory to a plurality of logical channels accommodated in said measured transmission link and comparing the measured intensity with said total value.

36. A control method for an optical communication network in which at least one optical transmission element is disposed in a plurality of optical transmission links which accommodate a plurality of logical channels, between a first optical switch and a second optical switch, the method comprising the steps of:
transmitting a setup message from a transmit site;
establishing a connection in said first optical switch in response to said setup message and a connection in said second optical switch in response to said setup message;
creating an entry in a memory in response to said control message for mapping at least one attribute of a logical channel accommodated in one of said transmission links to a reference optical intensity value;
measuring optical intensity of each of said optical transmission links;
comparing the detected optical intensity with the reference optical intensity mapped in said memory to at least one logical channel accommodated in said measured optical transmission link; and controlling said optical transmission element according to a result of the comparison step.

37. The control method of claim 36, wherein the comparison step comprises the steps of:
calculating a total value of reference optical intensity values mapped in said memory to a plurality of logical channels accommodated in said measured transmission link; and
comparing the measured intensity with said total value.

38. The control method of claim 36, further comprising the steps of:
transmitting a modify message from said transmit site; and
modifying said at least one attribute according to the modify message.

39. The control method of claim 36, further comprising the steps of:
transmitting a release message from said transmit site; and
responsive to said release message, clearing said connections from the first and second optical switches and deleting said entry from said memory.
